(19) United States
(12) Patent Application Publication
(10) Pub. No.: US 2007/0252921 A1
(43) Pub. Date: Nov. 1, 2007

(54) Display and a Method of Providing a Display

(75) Inventor: Peter Back Knudsen, Copenhagen K (DK)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 10/581,617

(22) PCT Filed: Dec. 5, 2003
(86) PCT No.: PCT/DK03/00839

§ 371 Date: Mar. 7, 2007

(51) Int. Cl. G02B 6/00

(52) U.S. Cl. 349/57; 349/187

(57) ABSTRACT

A display, such as for use in a mobile telephone, comprising a light transmissive display, such as a Liquid Crystal Display (LCD), having there under a light transmitting plate adapted to guide light therein and then through the light transmissive display. Between the light emitters and the plate, a number of tapered light guides are provided so that the space between the tapers may be used for e.g. electronic components. The use of the light guides provides more space for electronic components and furthermore provides a more freely selectable positioning of the light emitters.

The present invention relates to a display, such as a backlit LCD display, and a method of providing the display, which display takes up less space than conventional displays and may be provided with a large number of alternative shapes compared to the conventional displays.

In the prior art, LCD displays are backlit by providing the light from a direction perpendicular to the display and provided either in light guides guiding the light in the perpendicular direction, such as in EP-A-0 271 956, or guiding the light in a direction along the plane of the display and then directing the light out of the light guide and toward the display, such as in U.S. Pat. Nos. 6,241,919, 4,799,771, 4,630,895, and JP-A-11305229.

The disadvantage of the first type of display, naturally, is the large depth of the display. The disadvantage of the latter type of display is the fact that either oblong light emitters must be provided providing light e.g. along a full side of the display, or small-area light emitters are provided along a side thereof, whereby either dark spots are provided between the light emitters on the display. The areas between the light emitters and the active area of the display are lost or left unused due to these areas not being illuminated evenly.

The object of the present invention relates to the facilitating of using the areas of the display which would be unevenly backlit. Such use could be for other electrical components.

Another object of the invention relates to the providing a more freely positioning of the light emitters in relation to a light transmissive display, such as a LCD display.

In a first aspect, the invention relates to a display comprising:
a light transmissive display,
one or more light emitters,
a light guiding plate being at least substantially parallel with the light transmissive display and at least partly overlapping the light transmissive display, the plate being adapted to receive light from the emitter(s), guide the received light therein at least substantially in parallel to the light transmissive display, and to direct the light through the light transmissive display,

the display further comprising one or more tapered light guides each extending between the plate and one or more of the light emitter(s), each light guide being adapted to direct light from at least one light emitter into the plate.

In this context, a light transmissive display is normally a display through which light may be transmitted and in which elements are adapted to change color or polarization in order for the transmitted light to change characteristics in accordance with the change of the elements. A display of this type is a Liquid Crystal Display, LCD.

In the present context, the overlapping of the light transmissive display and the plate is an overlap when projected on to a plane defined by the light transmissive display. Normally, the light transmissive display and the plate will be flat and the light guided by the plate will be guided at least substantially along the plane.

Naturally, bent shapes of the plate/light transmissive display are quite possible and may be desired in a number of applications. In that situation, the plate and light transmissive display will still be parallel in that they will have corresponding shapes (normally equidistantly), such as two tubes having the same center axis. The only difference is that the light transmissive display has a non-flat shape. The plate will perform its function exactly as that of a plane plate (guide the light until it is to be directed toward the light transmissive display).

In the following, the area of the plate overlapping with the light transmissive display will be denoted an active area of the plate.

A large number of manners exist of having the light guiding plate direct the light therefrom and through the light transmissive display. The present invention is equally suited for all these manners.

In the present context, it is preferred that the tapered guides have the narrow portion at the light emitters and the wider portion at the plate. In this manner, the guides will facilitate the widening of the light beams from the light emitters toward the plate and thereby prevent loss of active area of the plate. Normally, the best introduction of the light is when it is introduced at least substantially parallel to the plane or direction of the plate at the position/side of light entry.

Naturally, the tapered guides may be flat and be positioned in a plane defined by the plate. Otherwise, they may have other shapes allowing positioning of the light emitters at more freely selectable positions.

The loss of active area of the plate may be reduced when the tapered light guide(s) is/are adapted to introduce light into a predetermined side of the plate, the light guide(s), at the side of the plate, together extend at least 80%, such as at least 90%, preferably at least 95% of a length of the side of the plate. In this manner, the dark and useless areas of the plate between the areas of light entry at the side of the plate may be reduced.

In one embodiment, the light guides are a single, monolithic element. In this situation or in the situation where also the plate forms part of the monolithic element, adjacent parts of two adjacent tapered light guides are preferably defined by a rounded shape. This rounded shape between these elements will avoid micro cracks, which may be formed due to thermal or physical stressing of the light guides.

In a preferred embodiment, the space between the tapered elements and/or the light emitters is used for e.g. holding/storing electrical elements.

In a preferred embodiment, each light emitter has a largest physical dimension being significantly shorter than a largest physical dimension of the plate. In this situation, the dimension is a dimension of the light emitting part, if the light emitter comprises other parts, such as a housing, connectors etc.

The largest physical dimension may be a diameter or a diagonal, and preferably this dimension of the plate is at least 10 times larger, such as at least 50 times larger, preferably at least 100 times larger than the largest dimension of the light emitter.

Thus, a suitable illumination may be obtained while still leaving room for e.g. other components or the like.

In this respect, preferably, the display comprises at the most 10 light emitters, such as at the most 5 light emitters, preferably at the most 3 light emitters. Due to the fact that the light emitters may be positioned more freely in respect of the plate, less light emitters may be used while still obtaining the desired illumination. Light emitters, such as LEDs are quite costly.

One of the advantages is that light emitters having a low divergence of the emitted beam need a larger distance to the plate in order to illuminate a given area. The present tapered light guides facilitate that without an excessive loss of area due to the area between the tapers still being useful.

In one embodiment, the light transmissive display and the plate each has a side facing the other, and wherein the side of the plate has an area not larger than 110% of the area of the side of the light transmissive display. Thus, the only surface loss of the plate is 10% or less. In this embodiment, a predetermined plate side facing the tapered light guides has a predetermined length, and a distance exists between the light emitters exceeding 25% of the length, such as a distance exceeding 50% of the length. Thus, a large distance may be obtained between the light emitters even though a small surface loss is obtained.

A second aspect of the invention relates to a mobile telephone comprising the above display. In mobile telephones, space is sparse, and the possibility of placing electronic elements between the light emitters is welcome as is the possibility of actually having a more freely positioning of the light emitters.

A third aspect of the invention relates to a method of producing a display, the method comprising:
providing a light transmissive display,
providing a light transmissive plate so as to overlap the light transmissive display in a predetermined area of the plate,
providing one or more light emitters adapted to emit light into the light transmissive plate,

wherein the step of providing the plate comprises removing tapered parts of the plate so as to provide a tapered part of the plate between each group of one or more light emitters and the predetermined area of the plate.

A fourth aspect of the invention relates to a method of producing a display, the method comprising:
providing a light transmissive display,
providing a light transmissive plate so as to overlap the light transmissive display in a predetermined area of the plate,
providing one or more light emitters adapted to emit light into the light transmissive plate, and
providing one or more tapered light guides between each group of one or more light emitters and the predetermined area of the plate.

This display corresponds to the above first aspect of the invention.

In the following, the invention will be described in relation to the drawing, wherein:

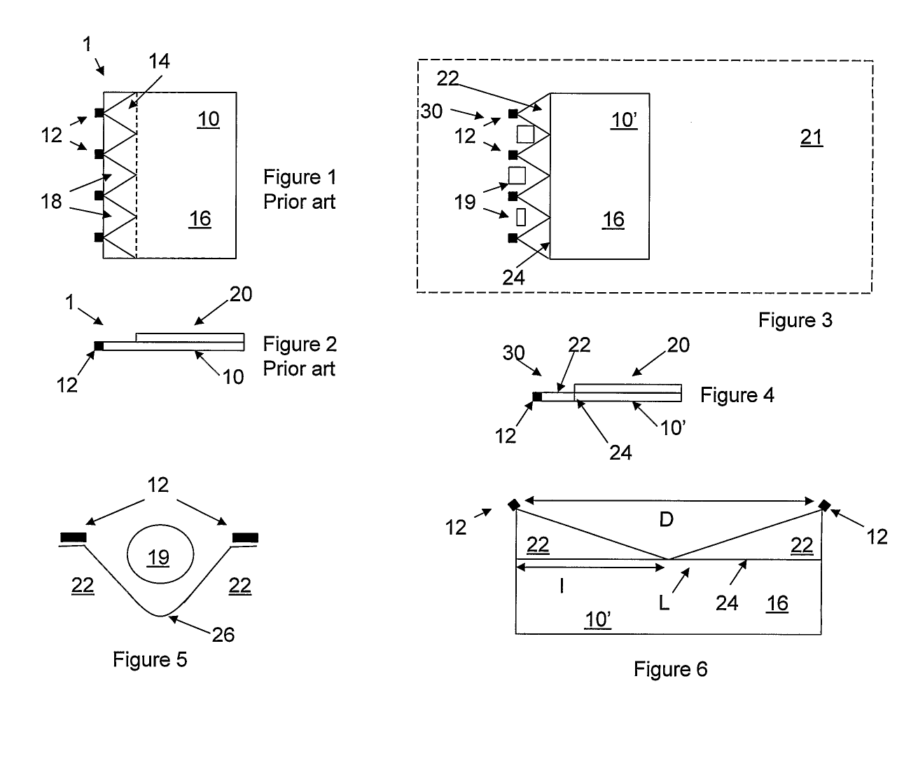

FIG. 1 illustrates in a top view a prior art backlit LCD display,

FIG. 2 illustrates the display of FIG. 1 from the side,

FIG. 3 illustrates a first embodiment according to the invention in a top view,

FIG. 4 illustrates the embodiment of FIG. 3 from the side,

FIG. 5 illustrates a detail of another preferred embodiment according to the invention, and

FIG. 6 illustrates a third embodiment according to the invention.

FIGS. 1 and 2 illustrate a prior art LCD display having the actual LCD 20 overlapping the back lighting light transmissive plate 10 which has an area extending outside the area of the LCD 20. In the present figure, 16 denotes the area of the plate 10 overlapping with the LCD (when projected onto a plane in which the plate 10 is). On an outer edge of the plate 10, four (as an example number) light emitters 12 are positioned so as to provide light into the plate 10 at that side.

It is clear that all types of light transmissive displays may be used in stead of the LCD.

However, due to the light emitting properties of the light emitters 12, black and bright spots or areas will be present in an area between the light emitters 12 and the area 16. This, actually, is the reason for the extra area.

The fans or tapers 14 illustrate the light emitted from the light emitters 12. It is seen that the areas 18 between the tapers 14 are dark and cannot be used for backlighting the LCD 20, wherefore the LCD is positioned only in the area 16 positioned sufficiently far from the light emitters 12 for it to be sufficiently evenly lit.

FIGS. 3 and 4 illustrate a first embodiment of the invention where, for the sake of simplicity, the four light emitters 12 are again used, as is the case for the area 16 overlapping with the LCD 20. In this embodiment, however, the plate, now denoted 10′, is smaller. In fact, the plate 10′ may be made to exactly fit the area 16. Also, instead of the area with the bright/dark areas 14 and 18, tapered light guides 22 are provided which are adapted to receive the light from the light emitters 12 and guide it to the edge 24 of the plate 10′. In this manner, areas corresponding to the dark areas 18 of the prior art may be used for e.g. electronic components 19.

The electronic components 19 may be components normally used for controlling the LCD 20 or for other uses depending on the actual use of the display 30. Thus, when, as is preferred, the display 30 is used in a mobile telephone, such as indicated by the square 21, the electronic components 19 may be components for use in other functionalities of the telephone 21.

As in the prior art, the plate 10′ and tapers 22 may be made of light transmissive plastics, glass or any other light guiding material.

Naturally, the light emitting characteristics (such as the emitting angles etc) of the light emitters 12 and the tapering shape and angle of the tapers 22 will define the manner in which the light enters the plate 10′ and, consequently, how the LCD 20 is backlit. However, these choices are quite simple. One example is to provide tapers 22 having a shape adapted to hold the full light emission of a light emitter 12 and being positioned so as to only guide the light as emitted without displacing the beam e.g. in other directions. This type of taper 22 will guide the light to the plate 10′ in the same manner as the areas 14 in the plate 10. Another possibility is the use of the tapers 22 to actually form the light beams to be emitted into the plate 10′. Thus a better diffusion may be provided (such as by providing diffusing surfaces of the taper) or a desired spreading of the light may be provided by simply providing a taper with a mirror/lens functionality.

The plate 10′ and the tapers 22 may be made as one monolithic element or may be made of individual elements assembled using e.g. the standard index matching glues or the like.

FIG. 5 illustrates an embodiment where the area at the surface 24 between two tapers 22 may be rounded. This rounded shape 26 may be provided by simply moulding the tapers 22 or monolithic element in that manner or by a combined drilling/cutting action of the tapers 22 or the monolithic element. This rounded shape, it is contemplated, will prevent micro cracks in the elements due to thermal or physical stresses.

FIG. 6 illustrates the versatility of the present invention in that only two light emitters 12 are used for illuminating the LCD. In this embodiment, the light emitters 12 are provided close to or at the extensions of two opposite edges of the plate 10′ in order to provide more space for e.g. electrical components there between. The tapers 22 are adapted to ensure that the light emitted from the emitters 12 illuminates the whole area 16 in a sufficient manner.

It is clear that the light emitters 12 need a certain distance to the area 16 in order for their beams to expand sufficiently to illuminate the whole area 16. If made in accordance with FIG. 1, this would require a large unused area of the plate 10.

In this embodiment, it is seen that the distance, D, between the light emitters is equal to the length, L, of the edge 24. Also, it is seen that the physical dimensions of the light emitters 12, typically being provided as LED's, but which may just as well be light provided in any other manner and which may be provided to the positions 12 using e.g. optical fibers or the like, is much smaller than L.

Also, it is seen that when only two light emitters 12 or tapers 22 are used, the tapers 22, at the surface 24, are wider (each having the width l) so as to prevent dark spots in the plate 10′. In this manner, the area of the plate 10′ may be identical to or close to the area 16.

Naturally, it is possible to use more than one light emitter 12 for each taper 22.

Thus, it is clear that the positions of the light emitters 12 may be chosen much more freely, and the tapers 22 may be used for guiding the light to the plate 10′, while still providing the desired illumination of the LCD.

1. A display comprising:
a light transmissive display,
one or more light emitters,
a light guiding plate being at least substantially parallel with the light transmissive display and at least partly overlapping the light transmissive display, the plate being adapted to receive light from the one or more light emitters, guide the received light therein at least substantially in parallel to the light transmissive display, and to direct the light through the light transmissive display,
the display further comprising one or more tapered light guides each extending between the plate and one or more of the light emitters, each light guide being adapted to direct light from at least one light emitter into the plate.

2. A display according to claim 1, wherein the one or more tapered light guides are adapted to introduce light into a predetermined side of the plate, the one or more light guides, at the side of the plate, together extend at least 80%, of a length of the side of the plate.

3. A display according to claim 1, wherein the one or more light guides are a single, monolithic element.

4. A display according to claim 3, where adjacent parts of two adjacent tapered light guides are defined by a rounded shape.

5. A display according to claim 1, further comprising electrical elements positioned between the one or more tapered light guides and the one or more light emitters.

6. A display according to claim 1, wherein each light emitter has a largest physical dimension being significantly lower than a largest physical dimension of the plate.

7. A display according to claim 6, comprising at the most 10 light emitters.

8. A display according to claim 1, wherein the light transmissive display and the plate each has a side facing the other, and wherein the side of the plate has an area not larger than 110% of the area of the side of the light transmissive display, wherein a predetermined plate side facing the tapered light guides has a predetermined length, and wherein a distance exists between the light emitters exceeding 25% of the length.

9. A mobile telephone comprising the display of claim 1.

10. A method of producing a display, the method comprising:
providing a light transmissive display,
providing a light transmissive plate so as to overlap the light transmissive display in a predetermined area of the plate,
providing one or more light emitters adapted to emit light into the light transmissive plate,
wherein the step of providing the plate comprises removing tapered parts of the plate so as to provide a tapered part of the plate between each group of one or more light emitters and the predetermined area of the plate.

11. A method of producing a display, the method comprising:
providing a light transmissive display,
providing a light transmissive plate so as to overlap the light transmissive display in a predetermined area of the plate,
providing one or more light emitters adapted to emit light into the light transmissive plate, and
providing one or more tapered light guides between each group of one or more light emitters and the predetermined area of the plate.
